(19) United States
(12) Patent Application Publication
(10) Pub. No.: US 2025/0119917 A1
(43) Pub. Date: Apr. 10, 2025

(54) WIRELESS COMMUNICATION METHOD AND DEVICES THEREOF

(71) Applicant: ZTE CORPORATION, Shenzhen (CN)

(72) Inventors: Jiajun XU, Shenzhen (CN); Jun XU, Shenzhen (CN); Bo DAI, Shenzhen (CN); Hong TANG, Shenzhen (CN); Mengzhu CHEN, Shenzhen (CN); Jianqiang DAI, Shenzhen (CN); Xiaoying MA, Shenzhen (CN)

(73) Assignee: ZTE CORPORATION, Shenzhen (CN)

(21) Appl. No.: 18/989,484

(22) Filed: Dec. 20, 2024

Related U.S. Application Data
(63) Continuation of application No. PCT/CN2022/144291, filed on Dec. 30, 2022.

(51) Int. Cl. H04W 72/21; H04L 1/1812; H04W 72/0446; H04W 72/1268

(52) U.S. Cl. CPC H04W 72/21; H04L 1/1812; H04W 72/0446; H04W 72/1268

(57) ABSTRACT

A wireless communication method for use in a wireless terminal is disclosed. The method comprises receiving, from a wireless network node, a control signaling, determining at least one of a first resource of first information or a second resource of second information, and transmitting at least one of first information on the first resource or second information on the second resource based on the control signaling if a condition is met, wherein the control signaling is a radio resource control (RRC) signaling.

### CROSS-REFERENCE TO RELATED PATENT APPLICATIONS

This application is a Continuation of PCT Application No. PCT/CN2022/144291, filed Dec. 30, 2022, incorporated herein by reference in its entirety.

### TECHNICAL FIELD

This document is directed generally to wireless communications.

### BACKGROUND

In beyond 5G and 6G communication, some of the promising services (e.g., extended reality XR service) are characterized by its quasi-periodicity (jitter impact), large and various data amount and stringent latency requirement. In the existing arts, configured grant (CG) is capable of conveying periodic data by preconfigured resource without a grant request and extra resource granted delay. However, owing to the service characteristic of the large and various data amount, the preconfigured resources are likely to be overly configured, resulting in resource waste and therefore low resource efficiency. Thus, how to apply the CG to future services should be discussed.

### SUMMARY

This document relates to methods, systems, and devices for uplink signaling transmissions, and in particularly to methods, systems, and devices for uplink signaling transmission in a case of uplink control information collision.

The present disclosure relates to a wireless communication method for use in a wireless terminal. The method comprises:
receiving, from a wireless network node, a control signaling,
determining at least one of a first resource of first information or a second resource of second information, and transmitting, to the wireless network node, at least one of first information on the first resource or second information on the second resource based on the control signaling if a condition is met.

Various embodiments may preferably implement the following features:

Preferably or in some embodiments, the control signaling is a radio resource control (RRC) signaling.

Preferably or in some embodiments, the first information is associated with configured grant (CG) resources.

Preferably or in some embodiments, the first information comprises at least one of resource release information, resource reuse information, resource recycling information, scheduling free information, scheduling release information, resource request information, scheduling request information or buffer size reporting information.

Preferably or in some embodiments, the second information comprises at least one of hybrid automatic re-transmission request acknowledgement (HARQ-ACK) information, scheduling request (SR) information, channel state information, data or HARQ-ACK multiplexing SR information (HARQ-ACK/SR).

Preferably or in some embodiments, the first information is transmitted through at least one of an uplink control information (UCI) signaling, or a media access control (MAC) control element (CE) signaling.

Preferably or in some embodiments, the second information is transmitted through at least one of a MAC CE signaling, a UCI signaling or a physical uplink shared channel (PUSCH).

Preferably or in some embodiments, the UCI signaling is CG-UCI.

Preferably or in some embodiments, at least one of a first priority of the first information or a second priority of the second information is determined by at least one of an RRC signaling, a MAC CE signaling, a downlink control information signaling, a predefined value, a traffic type, an information type, radio access network awareness information, or a number of resources.

Preferably or in some embodiments, transmitting at least one of the first information or the second information based on the control signaling if the condition is met comprises dropping the first information if the condition is met.

Preferably or in some embodiments, transmitting at least one of the first information or the second information based on the control signaling if the condition is met comprises dropping the second information if the condition is met.

Preferably or in some embodiments, transmitting at least one of the first information or the second information based on the control signaling if the condition is met comprises combining the first information with the second information if the condition is met.

Preferably or in some embodiments, combining the first information with the second information comprises:
concatenating the first information and the second information, or
multiplexing the first information into the second information.

Preferably, multiplexing the first information into the second information comprises:
multiplexing the first information into the second information via rate matching or puncturing,

Preferably or in some embodiments, power offset information for the rate matching or the puncturing is determined based on an RRC signaling.

Preferably or in some embodiments, a start position of multiplexing the first information into the second information is at least one of:
an N-th symbol among symbols which are not configured for transmitting a demodulation reference signal (DMRS) or UCI on the second resource of the second information, where N is a positive integer,
an M-th symbol after a 1st DMRS the second resource of the second information, where M is a positive integer, or
an L-th symbol after a last DMRS or a last UCI on the second resource of the second information, where L is a positive integer.

Preferably or in some embodiments, transmitting at least one of the first information or the second information based on the control signaling if the condition is met comprises: transmitting the first information and the second information separately if the condition is met.

Preferably or in some embodiments, the condition is associated with whether the first resource of the first information overlaps with the second resource of the second information.

Preferably or in some embodiments, wherein the condition includes/is that the first resource of the first information overlaps with the second resource of the second information, wherein transmitting at least one of the first information or the second information based on the control signaling if the condition is met comprises:
multiplexing the first information with the second information if the condition is met,
transmitting the first information and dropping the second information if a first priority of the first information is higher than a second priority of the second information and if the condition is met, or
dropping the first information and transmitting the second information if the first priority of the first information is lower than the second priority of the second information and if the condition is met.

Preferably or in some embodiments, the condition includes that the first resource of the first information does not overlap with the second resource of the second information, wherein transmitting at least one of the first information or the second information based on the control signaling if the condition is met comprises:
transmitting the first information and the second information if the condition is met.

Preferably or in some embodiments, the condition includes that the second information transmitted on a second channel comprising HARQ-ACK information associated with a first channel.

Preferably or in some embodiments, the first channel includes a physical downlink shared channel (PDSCH).

Preferably or in some embodiments, transmitting at least one of the first information or the second information based on the control signaling if the condition is met comprises combining the first information and the second information if a P-th symbol of an earliest second channel in a group of overlapped second channels in a slot is not earlier than a symbol which comprises a cyclic prefix (CP) and starts at T1 symbols after Q-th symbol of the first channel, wherein P, Q and T1 are positive integers.

Preferably or in some embodiments, the first channel includes a physical downlink control channel (PDCCH).

Preferably or in some embodiments, transmitting at least one of the first information or the second information based on the control signaling if the condition is met comprise combining the first transmission and the second transmission if a P-th symbol of an earliest second channel in a group of overlapped second channels in a slot is not earlier than a symbol which comprises a CP and starts at T2 symbols after Q-th symbol of the first channel reception, wherein P, Q and T2 are positive integers.

Preferably or in some embodiments, the second channel includes at least one PUSCH, wherein transmitting at least one of the first information or the second information based on the control signaling if the condition is met comprise combining the first transmission and the second transmission if a P-th symbol of an earliest second channel in a group of overlapped second channels in a slot is not earlier than a symbol which comprises a CP and starts at T3 symbols after Q-th symbol of the first channel, where P, Q and T3 are positive integers.

Preferably or in some embodiments, the second channel does not include any PUSCH, wherein transmitting at least one of the first information or the second information based on the control signaling if the condition is met comprise combining the first transmission and the second transmission if a P-th symbol of an earliest second channel in a group of overlapped second channels in a slot is not earlier than a symbol which comprises a CP and starts at T4 symbols after Q-th symbol of the first channel, where P, Q and T4 are positive integer.

Preferably or in some embodiments, the second channel includes at least one physical uplink control channel (PUCCH) or at least one PUSCH for the first information and the second information.

Preferably or in some embodiments, the condition includes a relationship between a number R of used resources in CG resources configured to the wireless terminal is less than a number S of the CG resources, where R and S are positive integers.

Preferably or in some embodiments, the condition includes that the number R is smaller than the number S, wherein transmitting at least one of the first information or the second information based on the control signaling if the condition is met comprises: transmitting the first information if the condition is met.

Preferably or in some embodiments, the condition includes that the number R is not less than the number S, wherein transmitting at least one of the first information or the second information based on the control signaling if the condition is met comprises: dropping the first information if the condition is met.

Preferably or in some embodiments, the condition includes whether a number U of unused resources in CG resources configured to the wireless terminal is equal to 0.

Preferably or in some embodiments, the condition includes that the number U is equal to 0, wherein transmitting at least one of the first information or the second information based on the control signaling if the condition is met comprises: dropping the first information if the condition is met.

Preferably or in some embodiments, the condition includes the number U being greater than 0, wherein transmitting at least one of the first information or the second information based on the control signaling if the condition is met comprises: transmitting the first information if the condition is met.

The present disclosure relates to a wireless communication method for use in a wireless network node. The method comprises:
transmitting, to a wireless terminal, a control signaling, and
receiving, from the wireless terminal, at least one of first information on a first resource or second information on a second resource based on the control signaling.

Various embodiments may preferably implement the following features:

Preferably or in some embodiments, the control signaling is a radio resource control (RRC) signaling

Preferably or in some embodiments, the control signaling is a radio resource control (RRC) signaling.

Preferably or in some embodiments, the first information is associated with configured grant (CG) resources.

Preferably or in some embodiments, the first information comprises at least one of resource release information, resource reuse information, resource recycling information, scheduling free information, scheduling release information, resource request information, scheduling request information or buffer size reporting information.

Preferably or in some embodiments, the second information comprises at least one of hybrid automatic re-transmission request acknowledgement (HARQ-ACK) information, scheduling request (SR) information, channel state information, data or HARQ-ACK multiplexing SR information (HARQ-ACK/SR).

Preferably or in some embodiments, the first information is transmitted through at least one of an uplink control information (UCI) signaling, or a media access control (MAC) control element (CE) signaling.

Preferably or in some embodiments, the second information is transmitted through at least one of a MAC CE signaling, a UCI signaling or a physical uplink shared channel (PUSCH).

Preferably or in some embodiments, the UCI signaling is CG-UCI.

Preferably or in some embodiments, the wireless communication method further comprises:
transmitting, to the wireless terminal, a priority indication signaling for indicating at least one of a first priority of the first information or a second priority of the second information,
the priority indication signaling comprises at least one of an RRC signaling, a MAC CE signaling, a downlink control information signaling or radio access network awareness information.

The present disclosure relates to a wireless terminal. The wireless terminal comprises:
a communication unit, configured to receive from a wireless network node, a control signaling, and
a processor, configured to determine at least one of a first resource of first information or a second resource of second information,
wherein the communication unit is further configured to transmit, to the wireless network node, at least one of first information on the first resource or second information on the second resource based on the control signaling if a condition is met.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to:
transmit, to a wireless terminal, a control signaling, and
receive, from the wireless terminal, at least one of first information on a first resource or second information on a second resource based on the control signaling.

Various embodiments may preferably implement the following feature:

Preferably or in some embodiments, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of first information according to an embodiment of the present disclosure.

FIG. 2 shows a schematic diagram of first information according to an embodiment of the present disclosure.

FIG. 3 shows a schematic diagram of first information according to an embodiment of the present disclosure.

FIG. 4 shows a schematic diagram of first information according to an embodiment of the present disclosure.

FIG. 5 shows a schematic diagram of a start position of multiplexing first information into second information according to an embodiment of the present disclosure.

FIG. 6 shows a schematic diagram of a start position of multiplexing first information into second information according to an embodiment of the present disclosure.

FIG. 7 shows a schematic diagram of a start position of multiplexing first information into second information according to an embodiment of the present disclosure.

FIG. 8 shows a schematic diagram of a start position of multiplexing first information into second information according to an embodiment of the present disclosure.

FIG. 9 shows a schematic diagram of a start position of multiplexing first information into second information according to an embodiment of the present disclosure.

FIG. 10 shows a schematic of a first channel and a second channel according to an embodiment of the present disclosure.

FIG. 11 shows a schematic of a first channel and a second channel according to an embodiment of the present disclosure.

FIG. 12 shows a schematic of a first channel and a second channel according to an embodiment of the present disclosure.

FIG. 13 shows an example of a schematic diagram of a wireless terminal according to an embodiment of the present disclosure.

FIG. 14 shows an example of a schematic diagram of a wireless network node according to an embodiment of the present disclosure.

FIG. 15 shows a schematic diagram of a wireless communication system according to an embodiment of the present disclosure.

FIG. 16 shows a flowchart of a method according to an embodiment of the present disclosure.

FIG. 17 shows a flowchart of a method according to an embodiment of the present disclosure.

### DETAILED DESCRIPTION

In the present disclosure, methods for uplink signaling transmissions in a case of a collision between new UCI and another UCI are disclosed. In an embodiment, the new UCI is associated with (re) scheduling information of CG resources.

In an embodiment, in response to the collision between the new UCI and another UCI having lower priority than the new UCI, the UE may perform corresponding operations based on Table 1 below.

TABLE 1
New UCI vs. UCI with low priority (using eMBB UCI as an example)

| | | | P/SP-CSI on | |
|---|---|---|---|---|
| | eMBB SR | eMBB HARQ-ACK | PUCCH | eMBB PUSCH |
| New UCI | A. Drop | A. Drop eMBB | A. Drop CSI | [symbol] B PUSCH |
| | eMBB SR | HARQ-ACK | | [symbol] UCI |
| | B. Drop New | B. Drop New | B. Multiplexing/ | [symbol] ing/Combination |
| | UCI | UCI | Combination | |
| | C. Multiplexing/ | C. Multiplexing/ | | |
| | Combination | Combination | | |

[symbol]

indicates data missing or illegible when filed

In an embodiment, in response to the collision between the new UCI and another UCI having higher priority than the new UCI, the UE may perform corresponding operations based on the following Table 2.

TABLE 2
New UCI vs. UCI with high priority
(taking uRLLC UCI as an example)

| | uRLLC SR | uRLLC HARQ-ACK | uRLLC PUSCH |
|---|---|---|---|
| New UCI | A. Drop | A. Drop uRLLC | A. Drop uRLLC |
| | uRLLC SR | HARQ-ACK | PUSCH |
| | B. Drop New | B. Drop New UCI | B. Drop New |
| | UCI | C. Multiplexing/ | UCI |
| | C. Multiplexing/ | Combination | C. Multiplexing/ |
| | Combination | | Combination |

In an embodiment, in response to the collision between the new UCI and another UCI having the same priority as the new UCI, the UE may perform corresponding operations based on Table 3 below.

TABLE 3
New UCI vs. UCI with the same priority

| | SR | HARQ-ACK | PUSCH |
|---|---|---|---|
| New UCI | A. Multiplexing/ | A. Multiplexing/ | A. Multiplexing/ |
| | Combination | Combination | Combination |

In an embodiment, if a Multiplexing/Combination timeline is satisfied, multiplexing/combination of the collided UCIs may be performed.

In an embodiment associated with the transmission of the new UCI, the new UCI is transmitted if certain condition(s) are satisfied.

In some embodiments, the UE receives a control signaling from a base station (BS). If a condition is fulfilled, the UE transmits first information or second information based on the control signaling.

In some embodiments, the UE receives the control signaling from the BS. If the condition is fulfilled, the UE transmits the first information and the second information based on the control signaling.

The following aspects are discussed in the subsequent paragraphs:
The interpretation of the first information and the second information;
The relationships between first information and the second information;
Transmissions of the first information and the second information; and
The interpretation of the condition.

### The Interpretation of First Information and Second Information

In some embodiments, the first information includes or is associated with at least one of: resource release, resource reuse, resource recycling, scheduling free, scheduling release, resource request, scheduling request and buffer size reporting. For example, the first information is associated with a CG transmission or resources configured for the CG transmission.

In an embodiment, the first information includes the resource release (information), which means/indicates that the resources (e.g., indicated by the resource release (information)) are released if/when the BS receives the first information.

In an embodiment, the first information includes the resource reuse (field), which means that the resources (e.g., indicated by the resource reuse (field)) are able to be reused if/when the BS receives the first information.

In an embodiment, the first information includes the resource recycling (field), which means that the resources (e.g., indicated by the resource recycling (field)) are able to be recycled for transmissions if/when the BS receives the first information.

In an embodiment, the first information includes the scheduling free (field), which means that the resources are free for scheduling when the BS receives the first information.

In an embodiment, the first information includes the scheduling release (field), which means that the resources (e.g., indicated by the scheduling release (field)) are not scheduled if/when the BS receives the first information.

In an embodiment, the first information includes the resource request (field), which means that there are resource requirements for transmissions when/if the BS receives the first information.

In an embodiment, the first information includes the scheduling request (field), which means that there is a scheduling requirement for transmissions when/if the BS receives the information.

In an embodiment, the first information includes the buffer size reporting (field), which means/indicates the buffer size for one or more logical channel group. The buffer size reporting (field) is used for reporting the buffer size to the BS, to help the BS to schedule transmissions.

In some embodiments, the second information comprises or is associated with at least one of:
Hybrid automatic re-transmission request-acknowledgement (HARQ-ACK) information
Scheduling request (SR) information;
Channel state information (CSI);
data;
HARQ-ACK information multiplexing SR information (HARQ-ACK/SR).

In some embodiments, the first information may be transmitted through at least one of:
UCI signaling (e.g., CG-UCI); or
Medium Access Control (MAC) Control Element (CE) signaling.

In an embodiment, the UCI signaling is a new dedicated UCI signaling, such as a resource release UCI signaling, a resource reuse UCI signaling, a resource recycling UCI signaling, a scheduling free UCI signaling, a scheduling release UCI signaling, a resource request UCI signaling, a scheduling request UCI signaling or a buffer size reporting UCI signaling.

In an embodiment, UCI signaling is a CG-UCI signaling.

As an alternative, the length of CG-UCI signaling is extended X bits and there is an additional field for indicating the first information, where X is a positive integer. For example, the content of the CG-UCI can be listed as the table below:

| Field | Bitwidth |
|---|---|
| HARQ process number | 4 |
| Redundancy version | 2 |
| New data indicator | 1 |
| Channel Occupancy Time (COT) sharing | ┌log₂C┐ if both higher layer parameter |
| information | ul-toDL-COT-SharingED-Threshold |
| | and higher layer parameter cg-COT- |
| | SharingList are configured, or if both |
| | higher layer parameter ue- |
| | SemiStaticChannelAccessConfig and |
| | higher layer parameter cg-COT- |
| | SharingList are configured, where C is |
| | the number of combinations |
| | configured in cg-COT-SharingList; |
| | 1 if higher layer parameter ul-toDL- |
| | COT-SharingED-Threshold is not |
| | configured, and if higher layer |
| | parameter ue- |
| | SemiStaticChannelAccessConfig is |
| | not configured, and if higher layer |
| | parameter cg-COT-SharingOffset is |
| | configured; |
| | 0 otherwise; |
| | If a UE indicates COT sharing other |
| | than “no sharing” in a CG PUSCH |
| | within the UE's initiated COT, the UE |
| | should provide consistent COT |
| | sharing information in all the |
| | subsequent CG PUSCHs, if any, |
| | occurring within the same UE's |
| | initiated COT such that the same DL |
| | starting point and duration are |
| | maintained. |
| resource release/resource reuse/resource | X |
| recycling/scheduling free/scheduling | |
| release/resource request/scheduling | |
| request/buffer size reporting | |

No matter whether the UCI signaling is a new dedicated UCI signaling or an extended CG-UCI signaling, there are X bits for representing the first information, wherein X is a positive integer. For example, X may be designed as:
X=1, indicating the field for the first information is 1 bit. In this case, the first information is represented by a flag. For instance, bit ‘1’ indicates the first information is valid, while bit ‘0’ indicates the first information is invalid, or
X>1, indicating the field for the first information is larger than 1 bit.

In an embodiment, the first information is represented by a bitmap, where the length of the bitmap is determined by a high layer parameter related to the number of transmission occasions in a period and each bit in the bitmap indicates the state of corresponding transmission occasion(s) in the period.

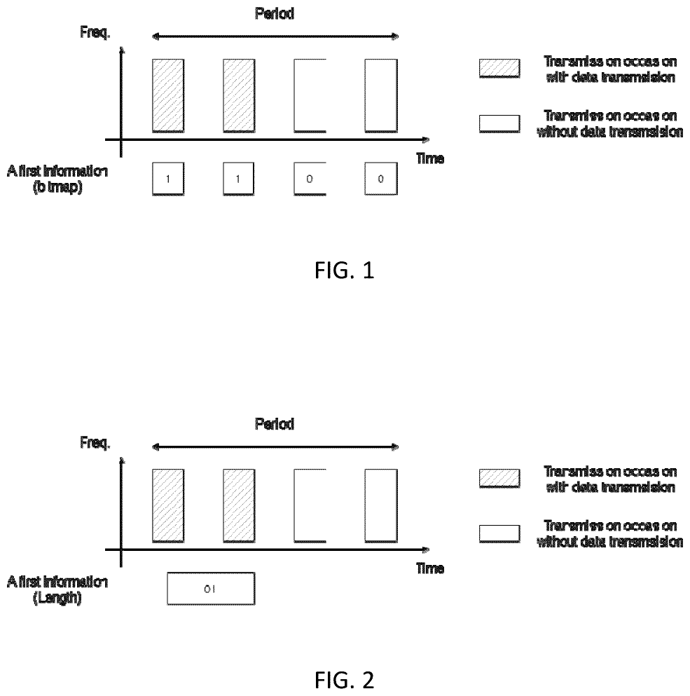

FIG. 1 shows a schematic diagram of the first information according to an embodiment of the present disclosure. In the embodiment shown in FIG. 1, the number of transmission occasions in the period is determined to be 4 based on the high layer parameter being 4 and the length of field (i.e., X bits) is determined to be 4. Regarding each bit in the bitmap, the bit ‘1’ represents the corresponding transmission occasion being configured for data transmission and bit ‘0’ represents the corresponding transmission occasion not being configured for data transmission (e.g., the corresponding transmission occasion is free or can be reused/rescheduled/released). In FIG. 1, the first two transmission occasions being used for the data transmissions and the bitmap is set to ‘1100’.

In an embodiment, the first information is represented by a number of transmission occasions, where the length of field (i.e., X bits) is determined by the high layer parameter related to the number of transmission in a period, and the decimal value corresponding to the binary value of the field indicates the number of transmission occasions in one state (e.g., with/without data transmission).

FIG. 2 shows a schematic diagram of the first information according to an embodiment of the present disclosure. In this embodiment, the high layer parameter indicates that the number of transmission occasions in the period is 4. In addition, the length of field (i.e., X bits) is determined to be 2. In FIG. 2, the first two transmission occasions are used for data transmissions and the value of the field is set to ‘01’. Note that the field may indicate that there are two transmission occasions in the period being in a state of being used for data transmissions or that there are two transmission occasions in the period being in a state of being unused for data transmissions.

In an embodiment, the first information is represented by a start and length indicator (SLIV) value for a starting transmission occasion and a number of transmission occasions in one state, where the length of field (i.e. X bits) is determined based on the maximum number of the SLIV, i.e. ┌log₂ SLIVₘₐₓ┐, where SLIVₘₐₓ denotes the maximum value of the SLIV.

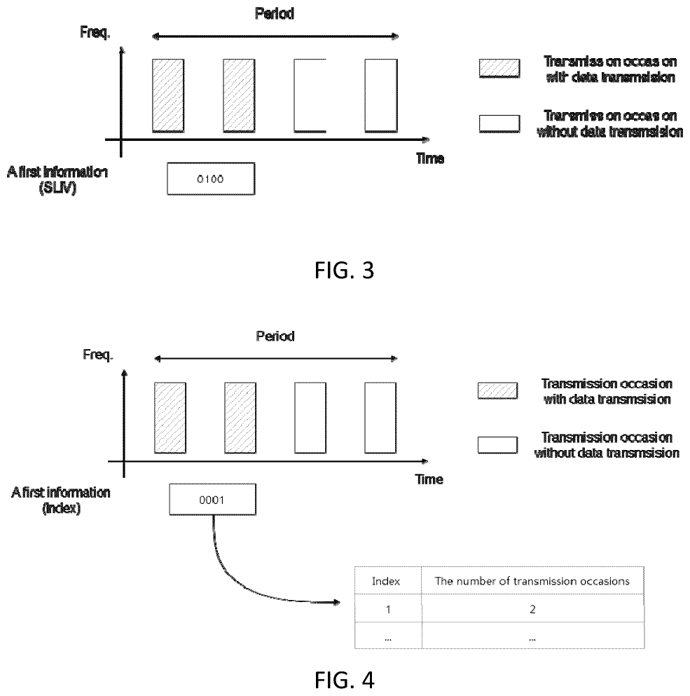

FIG. 3 shows a schematic diagram of the first information according to an embodiment of the present disclosure. In FIG. 3, the high layer parameter indicates that the number of transmission occasions in the period is 4. The length of field is ┌log₂9┐=4. In this embodiment, the first two transmission occasions are used for data transmissions (i.e., S=0, L=2). Thus, the value in the field is set to ‘0100’, representing SLIV=4.

In an embodiment, the rule for SLIV calculation based on S and L can be as follows:

if (^{L-1) ≤ N}_{_{TO}}^{/2} then
SLIV = N_{TO}·(L−1)+S
else
SLIV = N_{TO}·(N_{TO}−L+1)+(N_{TO}−1−S)

where N_{TO} is the number of transmission occasions in the period.

In an embodiment, the first information is represented by an index indicating a corresponding entry of a dedicated table, where the dedicated table includes at least indices and corresponding number of transmission occasions in one state and is determined by a high layer parameter. The length of field is determined by the maximum number of transmission occasions of the dedicated table. FIG. 4 shows a schematic diagram of the first information according to an embodiment of the present disclosure. In this embodiment, the dedicated table is determined by the high layer parameter, where a maximum of 16 transmission occasions can be indicated through this table. That is the length of field is 4. In FIG. 4, the first two transmission occasions are used for the data transmissions and the number 2 is indexed by ‘1’ in the table. Under such conditions, the value in the field is set to ‘0001’ as shown in FIG. 4.

Note that, in the above embodiments of the first information, the transmission occasions in one state can be either the transmission occasions with the data transmission or transmission occasion without the data transmission.

In some embodiments, the second information may be transmitted through at least one of:
MAC CE signaling;
UCI signaling (e.g., CG-UCI); or
Physical uplink shared channel (PUSCH).

### The Relationship Between First Information and Second Information

In some embodiments, the relationship between the first information and the second information refers to a relationship between a signaling configured to transmit the first information and a signaling or PUSCH configured to transmit the second information.

In some embodiments, the first information and the second information are transmitted through the UCI signaling. The relationships between the first information and the second information are according to at least one of the following embodiments.

In an embodiment, a first priority of the first information is higher than a second priority of the second information.

In an embodiment, the first priority of the first information is lower than the second priority of the second information.

In an embodiment, the first priority of the first information is the same as the second priority of the second information.

In some embodiments, the first priority for the first information and/or the second priority of the second information can be determined/indicated by at least one of the following embodiments.

In an embodiment, the first and/or second priority is determined by a high layer signaling (e.g., Radio resource control (RRC) signaling) or a MAC CE signaling.

For example, the first priority for the first information is determined by the RRC signaling (e.g., ResourceReleaseConfig, ResourceReuseConfig, Resource RecyclingConfig, SchedulingFreeConfig, SchedulingReleaseConfig, Resource RequestConfig or BufferSize ReportConfig) with a parameter for indicating the first priority of the first information, (e.g., the parameter may be phy-PriorityIndex-r18).

In an embodiment, p1 or p0 may be included in the parameter phy-PriorityIndex-r18, where p1 denotes that the first priority of the first information is high priority while p0 denotes that the first priority of the first information is low priority. The second priority of second information may be indicated as the first priority, e.g., by p0 and p1 in phy-PriorityIndex-r16, or ‘0’ and ‘1’ in “priority indication” field of DCI format. For example, the p1 priority for first information and p1 priority for second information are in the same high priority. While the p0 priority for first information and p0 priority for second information are in the same low priority.

In an embodiment, p2, p1 or p0 may be included in the parameter phy-PriorityIndex-r18, where p2 denotes that the first priority of the first information is extra high priority, p1 denotes that the first priority of the first information is high priority and p0 denotes that the first priority of the first information is low priority. The priority p1 and p0 for first information are the same as that of second signaling e.g., p0 and p1 in phy-PriorityIndex-r16, or ‘0’ and ‘1’ in “priority indication” field of DCI format. Moreover, the priority indicated by p2 for the first information represents a higher priority than the priority of the second information, e.g., p1 and p0 in phy-PriorityIndex-r16, or ‘0’ and ‘1’ in “priority indication” field of DCI format.

In an embodiment, p2, p1 or p0 may be included in the parameter phy-PriorityIndex-r18, where p1 denotes that the first priority of the first information is high priority and p0 denotes that the first priority of the first information is low priority, while p2 denotes that the first priority of the first information has a priority between the high priority and the low priority, such as a middle priority. The priority p1 and p0 for the first information is the same as that of the second information, e.g., p0 and p1 in phy-PriorityIndex-r16, or ‘0’ and ‘1’ in “priority indication” field of DCI format. While the priority p2 for the first information indicates that the priority is between the priorities indicated by p1 and p0 for the second information.

In an embodiment, the first and/or second priority is determined by the downlink control information (DCI) signaling.

In an embodiment, the first priority for the first information is determined by the DCI signaling, e.g., DCI format 0_1, or DCI format 0_2. For example, DCI format 0_1/0_2 is the activation DCI for configured grant scheduling, where C-RNTI is used to scramble DCI signaling and the field “HARQ Process Number” and/or field “Redundancy version” are/is re-interpreted to all zeros. In this example, the first priority is determined by the field “Priority indication” in DCI signaling, where a parameter priorityIndicatorDCI-0-1 or priorityIndicatorDCI-0-2 in RRC signaling is configured. The “Priority indication” indicates the first priority of the first information.

In an embodiment, the first priority of the first information is determined by the field “Priority indication” with 1-bit length in the DCI signaling. For example, the field indicating ‘1’ represents that the first information is high priority, while the field indicating ‘0’ represents that the first information is low priority. The high priority or the low priority indicated for the first information is the same as that for the second priority of second information, e.g., indicated by p0 and p1 in phy-PriorityIndex-r16, or ‘0’ and ‘1’ in “priority indication” field of DCI format.

In an embodiment, the first priority of the first information is determined by the field “Priority indication” with Y-bit length in the DCI signaling. In an example of Y=2, the field indicating ‘01’ represents that the first information is high priority, which is the same as the priority of the second information determined by the field “Priority indication” indicating ‘l’ or p1 in phy-PriorityIndex-r16, while the field indicating ‘00’ represents that the first information is low priority, which is the same as the priority of the second information determined by the field “Priority information” indicating ‘0’ or p0 in phy-PriorityIndex-r16. In addition, the field indicating ‘10’ represents that the first information is extra high priority, which is higher than the priority representation of ‘01’ and ‘00’, while the field indicating ‘11’ represents that the first information is ultra-high priority, which is higher than the priority representation of ‘10’, ‘01’ and ‘00’. In another example of Y=2, the field indicating ‘11’ represents that the first signaling is high priority, which is the same as the priority of the second information determined by the field “Priority indication” indicating ‘1’, while the field indicating ‘00’ represents that the first information is low priority, which is the same as the priority of the second information determined by the field “Priority information” indicating ‘0’. In this example, the field indicating ‘01’ or ‘10’ represents that the first signaling has a priority between high priority and low priority indicating ‘11’ and ‘00’, respectively, where the priority indicated by ‘10’ is higher than the priority indicated by ‘01’.

In an embodiment, the first priority of the first information is determined by a predefined value. For example, the first priority of the first information is predefined as high priority (e.g., p1).

As an alternative, the first priority of the first information is predefined as low priority (e.g., p0).

In an embodiment, the first priority of the first information is determined by a traffic type.

For example, the first priority of the first information is the high priority when the first information is for certain services including, e.g., uRLLC service or extended Reality service.

In an embodiment, the first priority of the first information is determined by an information type.

For example, if the first information is CSI report, the first information has low priority. While if the first information is information other than the CSI report, the first information has high priority.

In an embodiment, the first priority of the first information is determined by radio access network awareness information.

For example, the radio access network awareness information indicates the importance of data burst. Based on the radio access network awareness information, the first information has high priority when the first information is for the data burst with high importance, while the first information has low priority when the first information is for the data burst with low importance.

In an embodiment, the first priority of the first information is determined by a number of resources.

For example, the first information has high priority when the number of resources indicated by the first information is larger or less than a threshold, wherein the threshold is determined by a high layer parameter.

In another example, there are two first information, where one indicates a larger number of resources than another one. As a result, the first information indicating larger number of resources has high(er) priority.

If the above priority is not determined, the default priority of the first information and/or second information may be the lowest priority.

### Transmissions of First Information and Second Information

In some embodiments, the transmissions of the first information and the second information may refer to the transmissions of the first signaling configured to transmit the first information and the second signaling or PUSCH configured to transmit the second information.

The transmissions of the first information and the second information may be performed based on at least one of the following embodiments.

In an embodiment, the first information is dropped/canceled.

In an embodiment, the second information is dropped/canceled.

In an embodiment, the first information concatenates with the second information, where the first information is prior to the second information.

In an embodiment of the second information being the HARQ-ACK, the concatenation is the first information plus HARQ-ACK

In an embodiment of the second information being the SR, the concatenation is the first information plus SR.

In an embodiment of the second information being the CSI report, the concatenation is the first information plus CSI report.

In an embodiment of the second information being the HARQ-ACK/SR, the concatenation is the first information plus HARQ-ACK/SR.

In an embodiment, the first information concatenates with the second information, where the first information is after the second information.

In an embodiment of the second information being the HARQ-ACK, the concatenation is HARQ-ACK plus the first information.

In an embodiment of the second information being the SR, the concatenation is SR plus the first information.

In an embodiment of the second information being the CSI report, the concatenation is CSI report plus the first information.

In an embodiment of the second information being the HARQ-ACK/SR, the concatenation is HARQ-ACK/SR plus the first information.

In an embodiment, the first information is multiplexed into the second information.

In an embodiment of the second information being data, the first information is multiplexed into the data.

In an embodiment, the multiplex comprises rate matching or puncturing.

In an embodiment, power offset information of the rate matching or the puncturing is determined based on an RRC signaling.

In an embodiment, the power offset information is beta offset. If the first information is transmitted by a dedicated UCI signaling, the beta offset is determined by RRC signaling, e.g., ResourceReleaseConfig, ResourceReuseConfig, Resource RecyclingConfig, SchedulingFreeConfig, SchedulingReleaseConfig, Resource RequestConfig or BufferSize ReportConfig. 1f the first information is transmitted by the CG UCI signaling, the beta offset is reused.

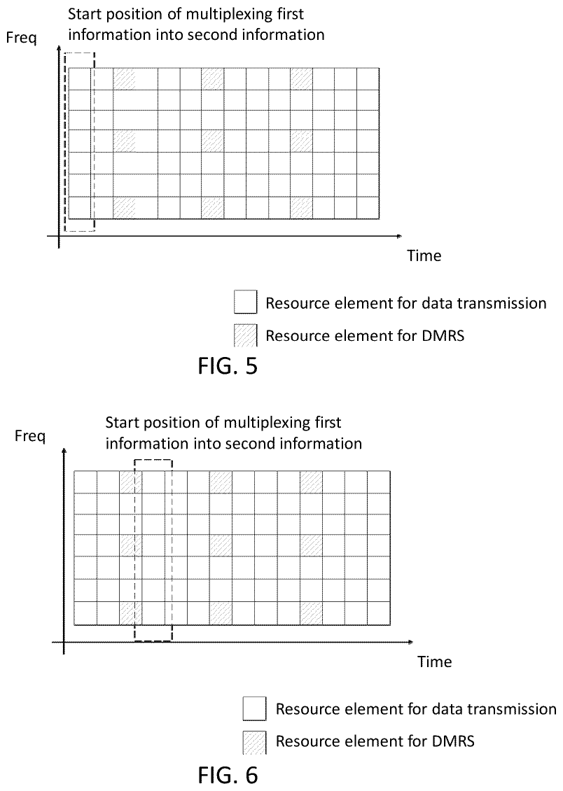

In an embodiment, a start position of multiplexing the first information into the second information is an N-th symbol among symbols which are not configured for transmitting a demodulation reference signal (DMRS) or UCI on a second resource of the second information, where N is a positive integer. For example, the N-th symbol may be the 1st symbol among the symbols which are not configured for transmitting the DMRS or UCI on the second resource of the second information as shown in FIG. 5.

In an embodiment, the start position of multiplexing the first information into the second information is an M-th symbol after a 1st DMRS in the second resource of the second information, where M is a positive integer. FIG. 6 shows a schematic diagram of the start position of multiplexing the first information into the second information according to an embodiment of the present disclosure. In FIG. 6, the M-th symbol may be the 1st symbol among the symbols which is after the 1st DMRS in the second resource of the second information.

In an embodiment, a start position of multiplexing the first information into the second information is an L-th symbol after a last DMRS or a last UCI on the second resource of the second information, where L is a positive integer.

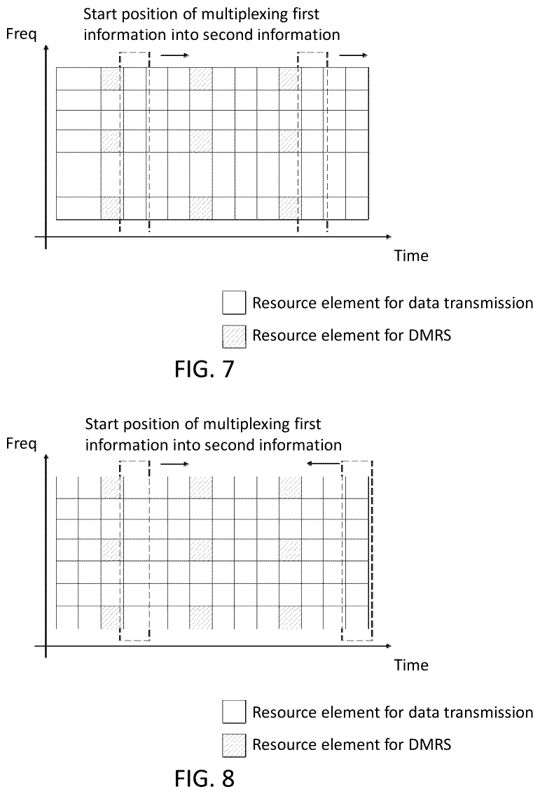

FIG. 7 shows a schematic diagram of the start position of multiplexing the first information into the second information according to an embodiment of the present disclosure. In this embodiment, the start position of multiplexing the first information into the second information comprises the first symbol which is not configured to transmit the first DMRS in the second resource of the second information and/or the first symbol which is not configured to transmit the last DMRS in the second resource of the second information. The symbols between the first DMRS symbol and the following DMRS symbol can be the one of the resources for multiplexing the first information. In addition, the symbols between the last DMRS symbol and the last symbol of PUSCH can be another resource for multiplexing the first information.

FIG. 8 shows a schematic diagram of the start position of multiplexing the first information into the second information according to an embodiment of the present disclosure. In FIG. 8, the start position of multiplexing the first information into the second information includes the first symbol not transmitting the first DMRS in the second resource of the second information and/or the last symbol not transmitting the last DMRS in the second resource of the second information. The symbols between the first DMRS symbol and the following DMRS symbol can be the one of resources for multiplexing the first information and the symbols between the last DMRS symbol and the last symbol of PUSCH can be another resource for multiplexing the first information. The difference between the embodiments shown in FIG. 8 and FIG. 7 is that the direction of the latter resource is from the last symbol of the second resource of the second information to the last DMRS symbol.

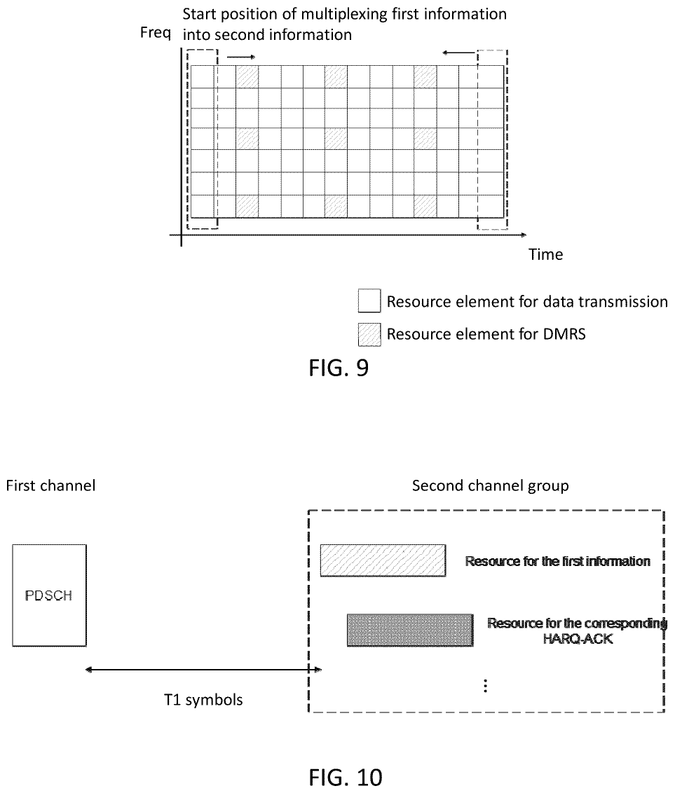

FIG. 9 shows a schematic diagram of the start position of multiplexing the first information into the second information according to an embodiment of the present disclosure. In this embodiment, the start position of multiplexing the first information into the second information includes the first symbol and/or the last symbol of second resource of the second information.

In an embodiment, the first information and the second information are multiplexed into the PUSCH.

In an embodiment, the rate matching is based on at least one of: the activation RRC signaling or activation DCI signaling.

In an embodiment, joint power offset information (e.g., beta offset) is used/configured for both the first information and the second information, wherein the offset information is determined by a high layer parameter.

In an embodiment, the power offset information (e.g., beta offset) used for the first information and the offset information used for the second information are separate information.

In an embodiment, the multiplex is based on orthogonal sequence. In this embodiment, a cyclic shift information for the orthogonal sequence may be used for distinguishing the first information and the second information.

In an embodiment, the first information and the second information may be respectively transmitted. In other words, the transmissions of the first information and the second information are separated.

### The Interpretation of Condition

In some embodiments, the condition includes whether the time domain resource of the first resource for the first information overlaps with the second resource for the second information or not.

In an embodiment, the time domain resource for the first information refers to the time domain resource configured to transmit the first information or the first signaling carrying the first information. Similarly, the time domain resource for the second information refers to the time domain resource configured to transmit the second information or the second signaling carrying the second information.

In an embodiment of the time domain resource for the first information overlapping with that for the second information, the first information (in the first signaling) is multiplexed with the second information (in the second signaling). In this embodiment, the first information and the second information may have the same priority or the first information and the second information may have different priorities.

In an embodiment of the time domain resource for the first information overlapping with that for the second information, the first information (in the first signaling) is transmitted and the second information (in the second signaling) is dropped/canceled if the first information has a higher priority than the second information.

In an embodiment of the time domain resource for the first information overlapping with that for the second information, the second information (in the second signaling) is transmitted and the first information (in the first signaling) is dropped if the first information has a lower priority than the second information.

In an embodiment of the time domain resource for the first information not overlapping with that for the second information, the first information (in the first signaling) and the second information (in the second signaling) are transmitted separately.

In some embodiments, the condition includes the timeline (condition) of resources of a first channel and a second channel on which the second information is transmitted. In this embodiment, the second information comprises the HARQ-ACK associated with the first channel.

In an embodiment, the first channel may include a physical downlink shared channel (PDSCH) and the second channel may include a physical uplink control channel (PUCCH) or a PUSCH. That is the condition may comprise a timeline of a PDSCH for the first information, and a PUCCH or PUSCH for the second information. For example, the condition may include (whether) P-th symbol of an earliest second channel in a group of overlapped second channels in a slot is not earlier than a symbol which comprises a cyclic prefix (CP) and starts at T1 symbols after Q-th symbol of the first channel, wherein P, Q and T1 are positive integers.

FIG. 10 shows a schematic diagram of the first channel and the second channel according to an embodiment of the present disclosure. In FIG. 10, the 1st symbol of the earliest second channel is T1 symbols after the last symbol of the first channel. Thus, the condition is met/fulfilled. The first information is transmitted on the second channel used for transmitting the second information.

In FIG. 10, the P-th symbol is the first symbol of the earliest second channel in the group of overlapped second channels in a slot and the Q-th symbol is the last symbol of the PDSCH. In addition, T1 is given by maximum of {T_{proc,1}^{mux,1}, . . . , T_{proc,1}^{mux,i}, . . . }, where for the i-th PDSCH (the first channel) with the corresponding HARQ-ACK transmission on a PUCCH which is in the group of overlapping PUCCHs and PUSCHs (i.e., the second channels), wherein T_{proc,1}^{mux,i}=(N₁+d_{1,1}+1)·(2048+144)·k·2^{-μ}·T_{c}, d_{1,1} is selected for the i-th PDSCH, N₁ is selected based on the UE PDSCH processing capability of the i-th PDSCH and SCS (subcarrier spacing) configuration μ, where μ corresponds to the smallest SCS configuration among the SCS configurations used for the PDCCH scheduling the i-th PDSCH, the i-th PDSCH, the PUCCH with the corresponding HARQ-ACK transmission for the i-th PDSCH, and all PUSCHs in the group of overlapping PUCCHs and PUSCHs.

In an embodiment, the first channel includes a physical downlink control channel (PDCCH) and the second channel includes a PUCCH or a PUSCH. The condition includes a timeline condition of the PDCCH and the PUCCH or PUSCH. For example, the condition may include (whether) P-th symbol of an earliest second channel in a group of overlapped second channels in a slot is not earlier than a symbol which comprises a CP and starts at T2 symbols after Q-th symbol of the first channel reception, wherein P, Q and T2 are positive integers.

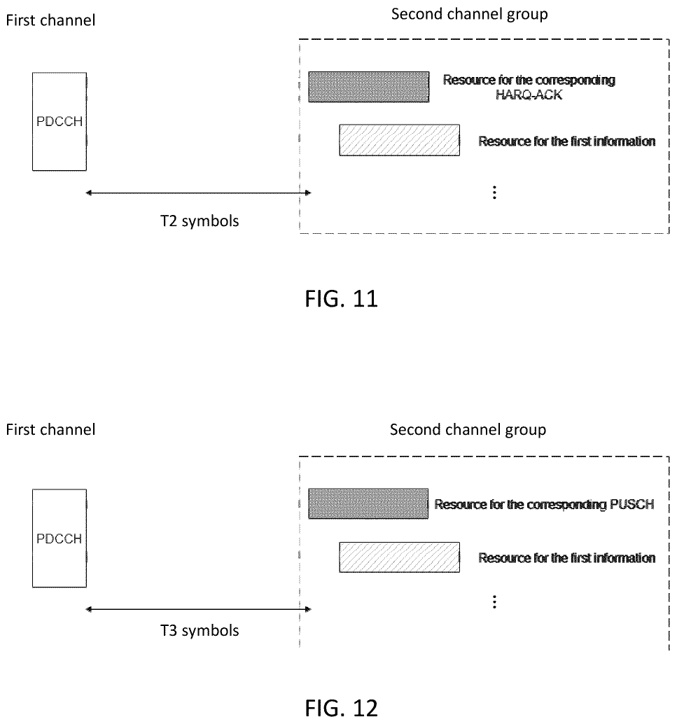

FIG. 11 shows a schematic diagram of the first channel and the second channel according to an embodiment of the present disclosure. In FIG. 11, the 1st symbol of the earliest second channel is T2 symbols after the last symbol of the first channel (i.e., PDCCH). Thus, the condition is met/fulfilled. The first information is transmitted on the second channel used for transmitting the second information.

Specifically, in FIG. 11, the P-th symbol is the first symbol of the earliest second channel in a group of overlapped second channels in a slot, the Q-th symbol is the last symbol of the PDCCH (e.g., for SPS release). In addition, T2 is given by the maximum of {T_{proc,release}^{mux,1}, . . . , T_{proc,release}^{mux,i}, . . . }, where for the i-th PDCCH (the first channel) providing the DCI format with the corresponding HARQ-ACK transmission on a PUCCH which is in the group of overlapping PUCCHs and PUSCHs (the second channel), T_{proc,release}^{mux,i}=(N+1)·(2048+144)·k·2^{-μ}·T_{c}, N is the symbol distance between PDCCH and HARQ-ACK, where μ corresponds to the smallest SCS configuration among the SCS configurations used for the PDCCH, the PUCCH with corresponding HARQ-ACK information, and all PUSCHs in the group of overlapping PUCCHs and PUSCHs.

In an embodiment, the first channel includes the PDCCH for uplink grant and the second channel includes at least one of PUSCH. The condition includes a timeline of the first channel and second channel. For instance, the condition includes (whether) P-th symbol of an earliest second channel in a group of overlapped second channels in a slot is not earlier than a symbol which comprises a CP and starts at T3 symbols after Q-th symbol of the first channel, where P, Q and T3 are positive integers.

FIG. 12 shows a schematic diagram of the first channel and the second channel according to an embodiment of the present disclosure. In FIG. 12, the 1^{st} symbol of the earliest second channel is T3 symbols after the last symbol of the first channel (i.e., PDCCH for uplink grant). Thus, the condition is met/fulfilled. The first information is transmitted on the second channel used for transmitting the second information.

Specifically, in FIG. 12, the P-th symbol is the first symbol of the earliest second channel is a group of overlapped second channels in a slot and the Q-th symbol is the last symbol of PDCCH (e.g., for uplink grant). In addition, T3 is given by the maximum of {T_{proc,2}^{mux,1}, . . . , T_{proc,2}^{mux,i}, . . . } where for the i-th PUSCH which is in the group of overlapping PUCCHs and PUSCHs (the second channel), T_{proc,2}^{mux,i}=max ((N₂+d_{2,1}+1)·(2048+144)·k·2^{-μ}·T_{c}+T_{switch}, d_{2,2}), d_{2,1}, d_{2,2} and T_{switch} are selected for the i-th PUSCH, N₂ is selected based on the UE PUSCH processing capability of the i-th PUSCH and SCS configuration μ, where μ corresponds to the smallest SCS configuration among the SCS configurations used for the PDCCH scheduling the i-th PUSCH, the PDCCHs scheduling the PDSCHs, or providing the DCI formats without scheduling PDSCHs, with corresponding HARQ-ACK information on a PUCCH which is in the group of overlapping PUCCHs/PUSCHs, and all PUSCHs in the group of overlapping PUCCHs and PUSCHs.

In an embodiment, the first channel includes the PDCCH for uplink grant and the second channel includes no PUSCH. The condition includes a timeline of the first channel and second channel. For instance, the condition includes (whether) P-th symbol of an earliest second channel in a group of overlapped second channels in a slot is not earlier than a symbol which comprises a CP and starts at T4 symbols after Q-th symbol of the first channel, where P, Q and T4 are positive integers.

For example, the P-th symbol is the first symbol of the earliest second channel is a group of overlapped second channels in a slot and the Q-th symbol is the last symbol of PDCCH (e.g., for uplink grant). In addition, T4 is given by maximum of {T_{proc,2}^{mux,1}, . . . , T_{proc,2}^{mux,i}, . . . } where for the i-th PDSCH (the first channel), or the i-th PDCCH providing a DCI format without scheduling PDSCH (the first channel), with corresponding HARQ-ACK information on a PUCCH which is in the group of overlapping PUCCHs, T_{proc,2}^{mux,i}=(N₂+1)·(2048+144)·k·2^{-μ}·T_{c}, N₂ is selected based on the UE PUSCH processing capability of the PUCCH serving cell if configured. N₂ is selected based on the UE PUSCH processing capability 1, if PUSCH processing capability is not configured for the PUCCH serving cell. μ is selected based on the smallest SCS configuration between the SCS configuration used for the PDCCH scheduling the i-th PDSCH, or providing the i-th DCI format without scheduling PDSCH, with corresponding HARQ-ACK information on a PUCCH which is in the group of overlapping PUCCHs, and the SCS configuration for the PUCCH serving cell.

In an embodiment, if the timeline of the first channel and the second channel is satisfied, the first information (in the first signaling) is combined/multiplexed with the second information (in the second signaling).

In some embodiments, when the first information is resource release, resource reuse, resource recycling, scheduling free, scheduling release or another information related to resource release, the condition includes whether the number R of used resources in resources (e.g., CG resources) configured for the UE is less than the number S of configured CG resources, where R and S are positive integers.

In an embodiment, the number S of the configured resources is determined by at least one of: RRC signaling, MAC CE signaling and DCI signaling.

In an embodiment, the number R of the used resources is determined by a time domain resource assignment in a slot, a frequency domain resource assignment in a slot, a modulation and coding scheme (MCS) level, and the number of layers in DCI format.

In an embodiment, if the number R of the used resources is less than the number S of the configured resources, the first information is transmitted.

In an embodiment, if the number R of the used resources is equal to the number S of the configured resources, the first information is not transmitted (i.e., the first information is dropped or cancelled).

In some embodiments, the condition includes whether the number U of unused resources U in the resources (e.g., CG resources) configured to the UE is equal to zero or not, wherein U is an integer.

In an embodiment, the number U of the unused resources is determined by the number R of the used resources and the number S of the configured resources. For example, U=S−R.

In an embodiment, if U is equal to zero, the first information is not transmitted (i.e., the first information is dropped or cancelled).

In an embodiment, if U is larger than zero, the first information is transmitted (through the first signaling).

In some embodiments, the condition includes or is associated with at least one of:
whether the time domain resource for the first information overlaps with that for the second information;
the condition includes the timeline (condition) of resources of a first channel and a second channel on which the second information is transmitted, wherein the second information comprises the HARQ-ACK associated with the first channel;
whether the number R of used resources in resources configured for the UE is less than the number S of configured CG resources, where R and S are positive integers; or
whether the number U of unused resources U in the resources (e.g., CG resources) configured to the UE is equal to zero or not, wherein U is an integer.

In some embodiments, when the first information is resource request, scheduling request and buffer size reporting or another information related to resource request, the condition includes whether the number R of used resources in resources (e.g., CG resources) configured for the UE is larger than the number S of configured CG resources, where R and S are positive integers.

In an embodiment, the number S of the configured resources is determined by at least one of: RRC signaling, MAC CE signaling and DCI signaling.

In an embodiment, the number R of the used resources is determined by a time domain resource assignment in a slot, a frequency domain resource assignment in a slot, a modulation and coding scheme (MCS) level, and the number of layers in DCI format.

In an embodiment, if the number R of the used resources is not less than the number S of the configured resources, the first information is transmitted.

In an embodiment, if the number R of the used resources is less than the number S of the configured resources, the first information is not transmitted (i.e., the first information is dropped or cancelled).

In an embodiment, the condition includes or is associated with:
whether the time domain resource for the first information overlaps with that for the second information; and
the condition includes the timeline (condition) of resources of a first channel and a second channel on which the second information is transmitted, wherein the second information comprises the HARQ-ACK associated with the first channel.

In an embodiment, the condition includes or is associated with:
whether the time domain resource for the first information overlaps with that for the second information; and
whether the number R of used resources in resources configured for the UE is less than the number S of configured CG resources, where R and S are positive integers.

In an embodiment, the condition includes or is associated with:
whether the time domain resource for the first information overlaps with that for the second information; and
whether the number U of unused resources U in the resources (e.g., CG resources) configured to the UE is equal to zero or not, wherein U is an integer.

In an embodiment, the condition includes or is associated with:
whether the time domain resource for the first information overlaps with that for the second information;
the condition includes the timeline (condition) of resources of a first channel and a second channel on which the second information is transmitted, wherein the second information comprises the HARQ-ACK associated with the first channel; and
whether the number R of used resources in resources configured for the UE is less than the number S of configured CG resources, where R and S are positive integers.

In an embodiment, the condition includes or is associated with:
whether the time domain resource for the first information overlaps with that for the second information;
the condition includes the timeline (condition) of resources of a first channel and a second channel on which the second information is transmitted, wherein the second information comprises the HARQ-ACK associated with the first channel; and
whether the number U of unused resources U in the resources configured to the UE is equal to zero or not, wherein U is an integer.

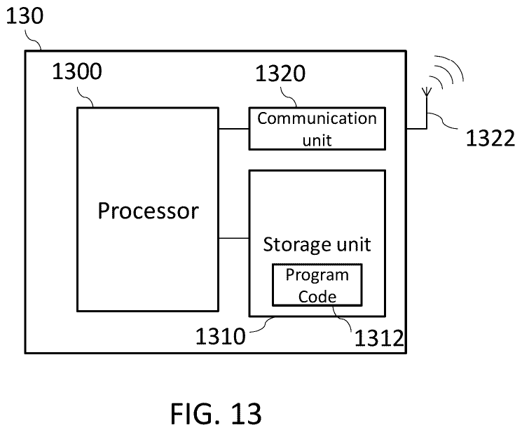

FIG. 13 relates to a schematic diagram of a wireless terminal 130 according to an embodiment of the present disclosure. The wireless terminal 130 may be a user equipment (UE), a mobile phone, a laptop, a tablet computer, an electronic book or a portable computer system and is not limited herein. The wireless terminal 130 may include a processor 1300 such as a microprocessor or Application Specific Integrated Circuit (ASIC), a storage unit 1310 and a communication unit 1320. The storage unit 1310 may be any data storage device that stores a program code 1312, which is accessed and executed by the processor 1300. Embodiments of the storage unit 1310 include but are not limited to a subscriber identity module (SIM), read-only memory (ROM), flash memory, random-access memory (RAM), hard-disk, and optical data storage device. The communication unit 1320 may a transceiver and is used to transmit and receive signals (e.g., messages or packets) according to processing results of the processor 1300. In an embodiment, the communication unit 1320 transmits and receives the signals via at least one antenna 1322 shown in FIG. 13.

In an embodiment, the storage unit 1310 and the program code 1312 may be omitted and the processor 1300 may include a storage unit with stored program code.

The processor 1300 may implement any one of the steps in exemplified embodiments on the wireless terminal 130, e.g., by executing the program code 1312.

The communication unit 1320 may be a transceiver. The communication unit 1320 may as an alternative or in addition be combining a transmitting unit and a receiving unit configured to transmit and to receive, respectively, signals to and from a wireless network node (e.g., a base station).

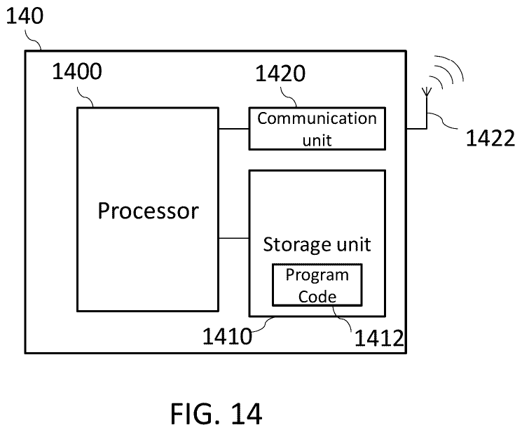

FIG. 14 relates to a schematic diagram of a wireless network node 140 according to an embodiment of the present disclosure. The wireless network node 140 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 140 may comprise (perform) at least one network function such as an access and mobility management function (AMF), a session management function (SMF), a user place function (UPF), a policy control function (PCF), an application function (AF), etc. The wireless network node 140 may include a processor 1400 such as a microprocessor or ASIC, a storage unit 1410 and a communication unit 1420. The storage unit 1410 may be any data storage device that stores a program code 1412, which is accessed and executed by the processor 1400. Examples of the storage unit 1410 include but are not limited to a SIM, ROM, flash memory, RAM, hard-disk, and optical data storage device. The communication unit 1420 may be a transceiver and is used to transmit and receive signals (e.g., messages or packets) according to processing results of the processor 1400. In an example, the communication unit 1420 transmits and receives the signals via at least one antenna 1422 shown in FIG. 14.

In an embodiment, the storage unit 1410 and the program code 1412 may be omitted. The processor 1400 may include a storage unit with stored program code.

The processor 1400 may implement any steps described in exemplified embodiments on the wireless network node 140, e.g., via executing the program code 1412.

The communication unit 1420 may be a transceiver. The communication unit 1420 may as an alternative or in addition be combining a transmitting unit and a receiving unit configured to transmit and to receive, respectively, signals to and from a wireless terminal (e.g., a user equipment or another wireless network node).

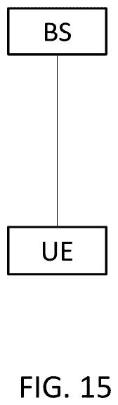

FIG. 15 shows a schematic diagram of a wireless communication system according to an embodiment of the present disclosure. The wireless communication system shown in FIG. comprises a UE and a BS. The UE is configured to receive a control signaling (e.g., RRC signaling) from the BS and transmit, if a condition is met, at least one of first information and second information based on the control signaling. Further detail of the operations of the UE and/or BS may be referred to the embodiments of the present disclosure.

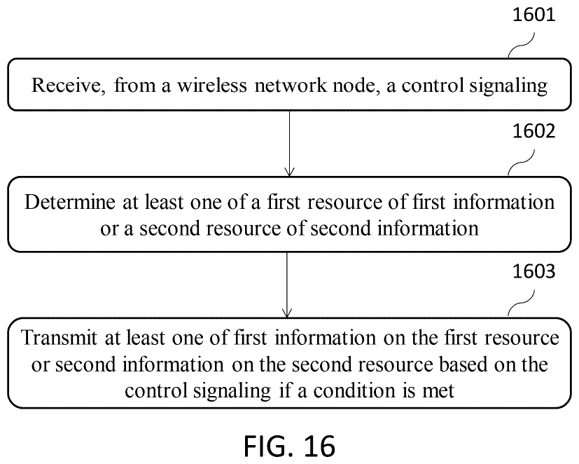

FIG. 16 shows a flowchart of a method according to an embodiment of the present disclosure. The method shown in FIG. 16 may be used in a wireless terminal (e.g., UE) and comprises the following steps:

Step 1601: Receive, from a wireless network node, a control signaling.

Step 1602: Determine at least one of a first resource of first information or a second resource of second information.

Step 1603: Transmit at least one of first information on the first resource or second information on the second resource based on the control signaling if a condition is met.

In FIG. 16, the wireless terminal receives a control signaling from a wireless network node (e.g., BS, RAN node, gNB). For example, the control signaling may be an RRC signaling. Because of possible collision of transmissions of first information and second information, the UE determines at least one of a first resource of rgw first information or a second resource of rgw second information and transmits at least one of the first information on the first resource or the second information on the second resource based on the control signaling if a condition is met/fulfilled.

In an embodiment, the first information is associated with CG resources. For example, the CG resources may be configured by the control signaling.

In an embodiment, the first information comprises at least one of resource release field/information, resource reuse field/information, resource recycling field/information, scheduling free field/information, scheduling release field/information, resource request field/information, scheduling request field/information or buffer size reporting field/information. The detail of each field comprised in the first information can be referred to aforementioned embodiments.

In an embodiment, the second information comprises at least one of HARQ-ACK (information), SR (information), CSI (report), data or HARQ-ACK multiplexing SR (HARQ-ACK/SR).

In an embodiment, the first information is transmitted through at least one of a UCI signaling (e.g., CG UCI signaling), or a MAC CE signaling.

In an embodiment, the second information is transmitted through at least one of a MAC CE signaling, a UCI signaling (e.g., CG UCI signaling) or a PUSCH.

In an embodiment, at least one of a first priority of the first information or a second priority of the second information is determined by at least one of an RRC signaling, a MAC CE signaling, a downlink control information signaling, a predefined value, a traffic type, an information type, radio access network awareness information, or a number of resources.

In an embodiment, the wireless terminal may drop/cancel the first information if the condition is met.

In an embodiment, the wireless terminal may drop/cancel the second information if the condition is met.

In an embodiment, the wireless terminal may combine the first information with the second information if the condition is met.

In an embodiment, the wireless terminal combines the first information with the second information via concatenating the first information and the second information or multiplexing the first information into the second information.

In an embodiment, the wireless terminal multiplexes the first information into the second information by:
multiplexing the first information into the second information via rate matching or puncturing.

In an embodiment, power offset information for the rate matching or the puncturing is determined based on an RRC signaling.

In an embodiment, a start position of multiplexing the first information into the second information is at least one of:
an N-th symbol among symbols which are not configured for transmitting a DMRS or UCI on the second resource of the second information, where N is a positive integer,
an M-th symbol after a 1st DMRS the second resource of the second information, where M is a positive integer, or an L-th symbol after a last DMRS or a last UCI on the second resource of the second information, where L is a positive integer.

In an embodiment, the wireless terminal transmits the first information and the second information separately if the condition is met.

In an embodiment, the condition is associated with or includes whether the first resource of the first information overlaps with the second resource of the second information.

In an embodiment, the condition is that the first resource of the first information overlapping with the second resource of the second information. In this embodiment, the wireless terminal may perform at least one of:
multiplexing the first information with the second information if the condition is met,
transmitting the first information and dropping the second information if a first priority of the first information is higher than a second priority of the second information and if the condition is met, or
dropping the first information and transmitting the second information if the first priority of the first information is lower than the second priority of the second information and if the condition is met.

In an embodiment, the condition includes that the first resource of the first information does not overlap with the second resource of the second information. In this embodiment, the wireless terminal transmits the first information and the second information if the condition is met.

In an embodiment, the condition includes that the second information transmitted on a second channel comprising HARQ-ACK (information) associated with a first channel.

In an embodiment, the first channel includes a PDSCH. In this embodiment, the wireless terminal may combine the first information and the second information if a P-th symbol of an earliest second channel in a group of overlapped second channels in a slot is not earlier than a symbol which comprises a CP and starts at T1 symbols after Q-th symbol of the first channel, wherein P, Q and T1 are positive integers.

In an embodiment, the first channel includes a PDCCH. In this embodiment, the wireless terminal combines the first transmission and the second transmission if a P-th symbol of an earliest second channel in a group of overlapped second channels in a slot is not earlier than a symbol which comprises a CP and starts at T2 symbols after Q-th symbol of the first channel reception, wherein P, Q and T2 are positive integers.

In an embodiment, the second channel includes at least one PUSCH. In this embodiment, the wireless terminal combines the first transmission and the second transmission if a P-th symbol of an earliest second channel in a group of overlapped second channels in a slot is not earlier than a symbol which comprises a CP and starts at T3 symbols after Q-th symbol of the first channel, where P, Q and T3 are positive integers.

In an embodiment, the second channel does not include any PUSCH. In this embodiment, the wireless terminal combines the first transmission and the second transmission if a P-th symbol of an earliest second channel in a group of overlapped second channels in a slot is not earlier than a symbol which comprises a CP and starts at T4 symbols after Q-th symbol of the first channel, where P, Q and T4 are positive integers.

In an embodiment, the second channel includes at least one PUCCH or at least one PUSCH (for the first information and the second information).

In an embodiment, the condition includes a relationship between a number R of used resources in CG resources configured to the wireless terminal is less than a number S of the CG resources, where R and S are positive integers.

In an embodiment, the condition includes/is that the number R being smaller than the number S. In this embodiment, the wireless terminal transmits the first information if the condition is met.

In an embodiment, the condition includes/is that the number R being not less than the number S. In this embodiment, the wireless terminal drops the first information if the condition is met.

In an embodiment, the condition includes whether a number U of unused resources in CG resources configured to the wireless terminal being equal to 0.

In an embodiment, the condition includes/is that the number U being equal to 0. In this embodiment, the wireless terminal drops the first information if the condition is met.

In an embodiment, the condition includes/is the number U being greater than 0. In this embodiment, the wireless terminal transmits the first information if the condition is met.

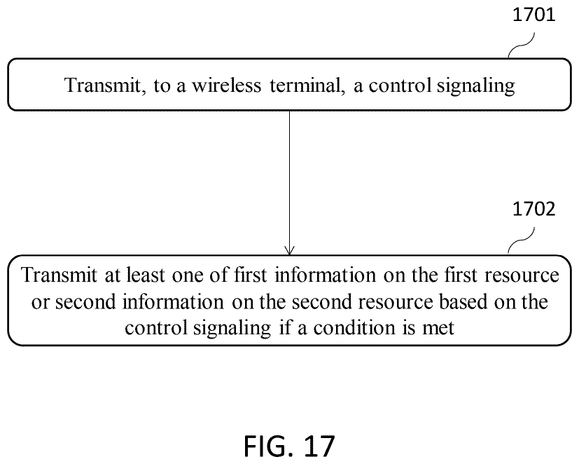

FIG. 17 shows a flowchart of a method according to an embodiment of the present disclosure. The method shown in FIG. 17 may be used in a wireless network node (e.g., BS) and comprises the following steps:

Step 1701: Transmit, to a wireless terminal, a control signaling.

Step 1702: Receive, from the wireless terminal, at least one of first information on a first resource or second information on a second resource based on the control signaling.

In FIG. 17, the wireless network node may transmit a control signaling (e.g., RRC signaling) to a wireless terminal. Due to possible collision of transmissions of first information and second information, the wireless network node may receive at least one of the first information on a first resource or the second information on a second resource based on the control signaling.

In an embodiment, the first information is associated with CG resources. For example, the CG resources may be configured by the control signaling.

In an embodiment, the first information comprises at least one of resource release field/information, resource reuse field/information, resource recycling field/information, scheduling free field/information, scheduling release field/information, resource request field/information, scheduling request field/information or buffer size reporting field/information. The detail of each field comprised in the first information can be referred to aforementioned embodiments.

In an embodiment, the second information comprises at least one of HARQ-ACK (information), SR (information), CSI (report), data or HARQ-ACK multiplexing SR (HARQ-ACK/SR).

In an embodiment, the first information is transmitted through at least one of a UCI signaling (e.g., CG UCI signaling), or a MAC CE signaling.

In an embodiment, the second information is transmitted through at least one of a MAC CE signaling, a UCI signaling (e.g., CG UCI signaling) or a PUSCH.

In an embodiment, the wireless network node transmits a priority indication signaling for indicating at least one of a first priority of the first information or a second priority of the second information. For example, the priority indication signaling comprises at least one of n RRC signaling, a MAC CE signaling, a DCI signaling or radio access network awareness information.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the wireless communication method comprising:
receiving, from a wireless network node, a control signaling,
determining at least one of a first resource of first information or a second resource of second information, and
transmitting, to the wireless network node, at least one of first information on the first resource or second information on the second resource based on the control signaling if a condition is met,
wherein the control signaling is a radio resource control (RRC) signaling.

2. The wireless communication method of claim 1, wherein the first information is associated with configured grant (CG) resources.

3. The wireless communication method of claim 1, wherein the first information comprises at least one of resource release information, resource reuse information, resource recycling information, scheduling free information, scheduling release information, resource request information, scheduling request information or buffer size reporting information.

4. The wireless communication method of claim 1, wherein the first information comprises a bitmap indicating the states of corresponding transmission occasions in a period and the first information is determined by a higher layer parameter related to the number of transmission occasions in a period, and wherein each bit in the bitmap indicates the states of corresponding transmission occasions in the period, where the state of the transmission occasion includes the transmission occasions with data transmission, or the transmission occasions without data transmission.

5. The wireless communication method of claim 1, wherein the second information comprises at least one of hybrid automatic re-transmission request acknowledgement (HARQ-ACK) information, scheduling request (SR) information, channel state information, data or HARQ-ACK multiplexing SR information (HARQ-ACK/SR).

6. The wireless communication method of claim 1, wherein the second information is transmitted through at least one of a medium access control control element (MAC CE) signaling, an uplink control information (UCI) signaling or a physical uplink shared channel (PUSCH).

7. The wireless communication method of claim 1, wherein transmitting at least one of the first information or the second information based on the control signaling if the condition is met comprises:
combining the first information with the second information if the condition is met.

8. The wireless communication method of claim 7, wherein combining the first information with the second information comprises:
concatenating the first information and the second information, wherein the concatenation is the first information plus the second information, or
multiplexing the first information into the second information.

9. The wireless communication method of claim 8, wherein multiplexing the first information into the second information comprises:
multiplexing the first information into the second information via rate matching,
wherein power offset information for the rate matching is determined based on an RRC signaling, and/or
wherein a start position of multiplexing the first information into the second information is:
an M-th symbol after a 1st demodulation reference signal (DMRS) in the second resource of the second information, where M is a positive integer.

10. A wireless communication method for use in a wireless network node, the wireless communication method comprising:
transmitting, to a wireless terminal, a control signaling, and
receiving, from the wireless terminal, at least one of first information on a first resource or second information on a second resource based on the control signaling,
wherein the control signaling is a radio resource control (RRC) signaling.

11. The wireless communication method of claim 10, wherein the first information is associated with configured grant (CG) resources.

12. The wireless communication method of claim 10, wherein the first information comprises at least one of resource release information, resource reuse information, resource recycling information, scheduling free information, scheduling release information, resource request information, scheduling request information or buffer size reporting information.

13. The wireless communication method of claim 10, wherein the first information comprises a bitmap indicating the states of corresponding transmission occasions in a period and the first information is determined by a higher layer parameter related to the number of transmission occasions in a period, and wherein each bit in the bitmap indicates the states of corresponding transmission occasions in the period, where the state of the transmission occasion includes the transmission occasions with data transmission, or the transmission occasions without data transmission.

14. The wireless communication method of claim 10, wherein the second information comprises at least one of hybrid automatic re-transmission request acknowledgement (HARQ-ACK) information, scheduling request (SR) information, channel state information, data or HARQ-ACK multiplexing SR information (HARQ-ACK/SR).

15. The wireless communication method of any of claim 10, wherein the second information is received through at least one of a medium access control control element (MAC CE) signaling, an uplink control information (UCI) signaling or a physical uplink shared channel (PUSCH).

16. A wireless terminal, comprising:
a communication unit, configured to receive from a wireless network node, a control signaling, and
at least one processor, configured to determine at least one of a first resource of first information or a second resource of second information,
wherein the communication unit is further configured to transmit, to the wireless network node, at least one of first information on the first resource or second information on the second resource based on the control signaling if a condition is met,
wherein the control signaling is a radio resource control (RRC) signaling.

17. A wireless network node, comprising:
a communication unit configured to perform the method of claim 10.

18. A non-transitory computer-readable program medium with code stored thereupon, the code, when executed by at least one processor, causes the at least one processor to implement a wireless communication method recited in claim 1.

19. A non-transitory computer-readable program medium with code stored thereupon, the code, when executed by at least one processor, causes the at least one processor to implement a wireless communication method recited in claim 10.
